(19) United States
(12) Patent Application Publication
(10) Pub. No.: US 2008/0121504 A1
(43) Pub. Date: May 29, 2008

(54) ELECTRICAL CONTACT SYSTEM FOR AN ELECTRICAL SWITCHING DEVICE

(75) Inventors: Ruben Vogelsang, Zurich (CH); Jean-Claude Mauroux, Hunzenschwil (CH); Martin Lakner, Gebenstorf (CH); Thomas Schoenemann, Schafisheim (CH)

Correspondence Address: BUCHANAN, INGERSOLL & ROONEY PC, POST OFFICE BOX 1404, ALEXANDRIA, VA, 22313-1404, US

(73) Assignee: ABB TECHNOLOGY AG, Zurich (CH)

(21) Appl. No.: 11/941,323

(22) Filed: Nov. 16, 2007

(30) Foreign Application Priority Data
Nov. 23, 2006 (EP) 06405490.1

(51) Int. Cl. H01H 1/50

(52) U.S. Cl. 200/251

(57) ABSTRACT

An electrical contact system for an electrical switching device is proposed, which has two contact units and in which a contact force acts between the contact unit and the contact unit when an electrical contact is made, wherein means are provided to exert the contact force, and wherein the first contact unit can be disconnected from the second contact unit. The means are distinguished in that they have a thermal expansion effect which results in an increase in the contact force as the temperature of the means rises.

### RELATED APPLICATION

This application claims priority under 35 U.S.C. §119 to European Patent Application No. 06405490.1 filed in the European Patent Office on 23 Nov. 2006, the entire contents of which are hereby incorporated by reference in their entireties.

### TECHNICAL FIELD

The disclosure relates to the field of switchgear, and in particular an electrical contact system is disclosed for making an electrical contact in an electrical switching device, and an electrical switching device is disclosed.

### BACKGROUND INFORMATION

Electrical switches with electrical contact systems are generally used in order to interrupt and to reproduce the energy flow in a power supply system. Switches such as these are used at all voltage levels in the power supply system. During normal operation, the resistance of the switch must be as low as possible in order to keep the corresponding power losses low. During switching, the switch must be able to switch high currents during normal operation, and even greater currents in the event of a short circuit. Switches are known from the prior art in which the contact surfaces are coated with a thin layer of silver and in which the contact and the mating contact of the switch are pressed against one another in a sprung manner in order to increase the electrical conductivity in the contact area. European Patent Specification EP 0844631 discloses a switchable electrical contact system for a grounding switch, which has a contact pin and a mating contact in the form of a tulip. In order to make an electrical contact, the sprung contact fingers of the mating contact are pushed onto the contact pin, with the individual contact fingers pressing on the contact pin in a sprung manner.

The electrical contact between the contact and the mating contact is worth improving in this and other electrical contact systems. For example, if the contacts become dirty or oxidized, the contact resistance is increased and the electrical conductivity is in consequence not optimum, thus leading to wear phenomena and to undesirable heating of the contacts. The operation of the switch often also results in the contacts becoming eroded in the surface area, which contributes to a reduction in the electrical conductivity, for example in the case of surface-coated contacts or contacts which operate in an SF₆ gas atmosphere, thus likewise leading to undesirable heating in the contact area. This results in shorter life and a large amount of maintenance effort for the switching device.

### SUMMARY

The present disclosure attempts to reduce at least some of the problems mentioned above. The object is achieved by an electrical contact system and by an electrical switching device.

According to one aspect of the disclosure, an electrical contact system for an electrical switching device is proposed, which has a first and a second contact unit, wherein a contact force acts between the first and the second contact unit when an electrical contact is made. Furthermore, means are provided for exerting the contact force, that is to say, when an electrical contact is made, the means exert a force from the first contact unit on the second contact unit or from the second contact unit on the first contact unit, or from both contact units against one another. The first contact unit can be disconnected from the second contact unit by increasing the distance between the two contact units. In this case, the contacts are not disconnected by the means for exerting the contact force. When disconnected, there is no electrical contact between the first and the second contact units. The electrical contact system according to the disclosure is characterized in that the means for exerting the contact force have a thermal expansion effect which results in an increase in the contact force as the temperature of the means rises, that is to say if heating occurs, this leads to thermal expansion in the means, which can be described by the coefficient of expansion of the means and the temperature change in the means. In this case, it is completely irrelevant how heat is supplied to the means. An improvement in the electrical and mechanical contact in the contact area can be achieved in widely differing conditions, for both a high and a low contact force. The automatic increase in the contact force as the temperature rises during operation of the switch advantageously leads to a reduction in the contact resistance, and thus to increased conductivity in the contact area. Furthermore, during connection, the erosion in the contact area of the contact units of the switch is advantageously reduced by the lower contact force, thus considerably increasing the life of the contact units in the switch.

According to a further aspect of the disclosure, an electrical switching device, in particular a circuit breaker, is proposed. The electrical switching device has an electrical contact system.

### BRIEF DESCRIPTION OF THE DRAWINGS

Further advantages, features, aspects and details of the disclosure will be explained in more detail in the following text with reference to exemplary embodiments which are illustrated in the attached drawings, in which, schematically:

FIG. 1 shows two views of a contact unit according to the disclosure at different temperatures; contact unit at an increased temperature in the dashed illustration;

FIGS. 2a, b each show a view of a contact unit with a bimetallic spring at a different temperature;

FIG. 3 shows a view of a contact unit s whose contact finger is a bimetallic contact finger;

FIG. 4 shows a view of a contact system with contact fingers according to the disclosure arranged in an annular shape, and with a cylindrical mating contact;

FIG. 5 shows a view of a contact unit with a bimetallic contact spring and a bimetallic mating contact spring;

FIG. 6 shows a view of a contact system in which the contacts, which are arranged in an annular shape, are held by bimetallic springs;

FIG. 7 shows a calculated contact temperature/force curve for two contact fingers composed of different bimetallic material.

### DETAILED DESCRIPTION

The reference symbols used in the drawings and their meanings are listed in a summarized form in the list of reference symbols. In principle, identical parts or parts having the same effect are provided with the same or similar reference symbols in the figures. Parts which are not significant to understanding the disclosure are in some cases not illustrated. The described exemplary embodiments represent examples of the subject matter of the disclosure, and have no restrictive effect.

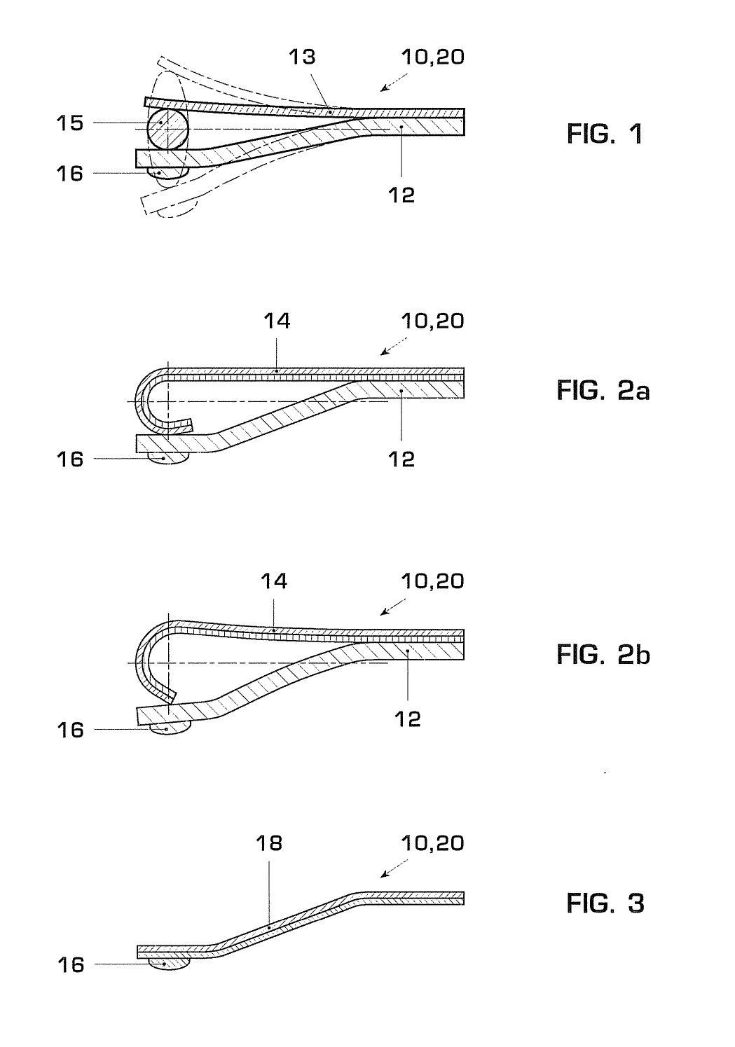

FIG. 1 shows a schematic view of a contact finger 12, a leaf spring 13 and an expansion body 15 of a contact unit 10, 20, which are parts of an electrical contact system which is not illustrated in any more detail. The leaf spring 13 extends essentially along the length of the contact finger 12 and is connected at one of its ends firmly to one end of the contact finger 12. The expansion body 15 is located between the leaf spring 13 and the contact finger 12 and may, for example, be clamped in between the leaf spring 13 and the contact finger 12. When heat is supplied to the contact unit 10, 20, for example caused by an electrical current flow or by the medium which surrounds the contact unit, this results to a particular extent in an expansion in the volume of the expansion body which, for example, is composed of an aluminum-bronze alloy and has a comparatively high coefficient of expansion, in comparison to the material of the contact finger 12 and of the leaf spring 13, which is composed, for example, of a steel alloy. The heat supply and therefore the increase in temperature of the expansion body therefore leads to spreading of the contact fingers 12 and leaf spring 13 (dashed-dotted illustration). The spreading caused by the supply of heat increases the contact force which is exerted by the contact finger 12 on a mating contact, which is not illustrated in any more detail.

FIGS. 2a and 2b each show a view of a contact unit 10, 20 of a contact system which is not illustrated but comprises a bimetallic spring 14 and a contact finger 12. At one of its ends, the bimetallic spring 14 is curved in a semicircular shape and, at this end, presses on the contact finger 12. By way of example, the contact finger 12 is formed from metal laminate stacks, and can therefore be deformed elastically. The contact finger 12 may, however, just as well be formed integrally and may have elasticity. FIG. 2b shows the contact unit 10, 20 after heat has been supplied to it. The different coefficients of expansion of the two metals in the bimetallic spring 14 result in a change in shape in the spring 14. The curved area of the spring 14 is widened, and therefore increases the spring force with which the spring 14 presses the contact finger 12 against a mating contact, which is not illustrated. When the heat that is being absorbed is emitted from the contact unit 10, 20, the spring force of the bimetallic spring 14 decreases, and the contact finger 12 and spring 14 return to their original state, as shown in FIG. 2a. The contact unit 10 illustrated in FIGS. 2a, 2b is therefore distinguished in that the means 14, which is a bimetallic spring, has a thermal expansion effect which leads to an increase in the contact force.

FIG. 3 shows a further exemplary embodiment of the contact unit 10, 20 in which the self-sprung contact finger 18 is composed of a bimetallic strip. In consequence, the two functions, that of making electrical contact and that of increasing the contact force, through a bimetallic spring, are combined in a single element, the contact finger 18. The bimetallic contact finger 18 is therefore itself a means for increasing the contact force. If the self-sprung contact finger 18 is regarded as a bar that is clamped in at one end, the force F produced by the finger and its deflection s from the rest position can easily be calculated for a given geometry. The deflection s of the finger from the rest position is obtained as follows on the basis of the different thermal expansion in the bimetallic strip:

L=L₀(1+α·ΔT)=L₀+s,

where α is the coefficient of expansion, for example for copper, aluminum/bronze, and zinc:

α_{Cu}=16.5 10⁻⁶ I/K

α_{Al-bronze}=24.0 10⁻⁶ I/K

α_{Zn}=30.2 10⁻⁶ I/K

and L₀ is the length of the bimetallic bar while ΔT is its temperature difference. Assuming values of ΔT=60 K and L₀=72 mm, the change in length L or the deflection s of the bar becomes:

$${L}_{Cu} = 72 mm ( 1 + 16 \frac{1}{K} \cdot {10}^{- 6} \cdot 60 K ) = 72 mm + 0.07 mm$$

$${L}_{Al \text{-} bronze} = 72 mm ( 1 + 24 \frac{1}{K} \cdot {10}^{- 6} \cdot 60 K ) = 72 mm + 0.10 mm$$

$${L}_{Zn} = 72 mm ( 1 + 30.2 \frac{1}{K} \cdot {10}^{- 6} \cdot 60 K ) = 72 mm + 0.13 mm$$

The force F acting on the bimetallic bar which is clamped in at one end, as illustrated in FIG. 3, is obtained from the product of its modulus of elasticity E times the axial area moment of inertia Jₐ and its deflection s, as well as the quotient from its length L₀:

$$F = \frac{8 {EJ}_{a}}{{L}_{0}^{3}} \cdot s$$

The area moment of inertia Jₐ of a rectangular geometry of the finger is given by:

$${J}_{a} = \frac{{bh}^{3}}{12}$$

$${J}_{a} = \frac{2.5 mm \cdot {( 10 mm )}^{3}}{12} = 208 {mm}^{4}$$

The following values were assumed for the moduli of elasticity:

E_{Cu}=11.2*10¹⁰ Pa

E_{Zn}=5*10¹⁰ Pa

A mean value of Pa=8*10⁴ N/mm² which results from this leads to a force of:

$$F = \frac{8 \cdot 8 \cdot {10}^{4} N \cdot 208 {mm}^{4}}{{( 72 mm )}^{3} {mm}^{2}} \cdot 0.06 mm = 21.4 N$$

for a copper/zinc bimetallic strip with a temperature difference of 60 K.

In comparison with this, the pure spring force ignoring any bimetallic effect for a contact finger which is clamped in at one end and taking into account the abovementioned parameters is 34 N.

The contact force of the finger can therefore be increased or reduced by more than 50% by means of a contact finger 12, 18 which is clamped in at one end and is composed of a bimetallic strip and has the parameters mentioned above, in comparison to a contact finger without a bimetallic effect, when the finger is subjected to a temperature difference of 60 K.

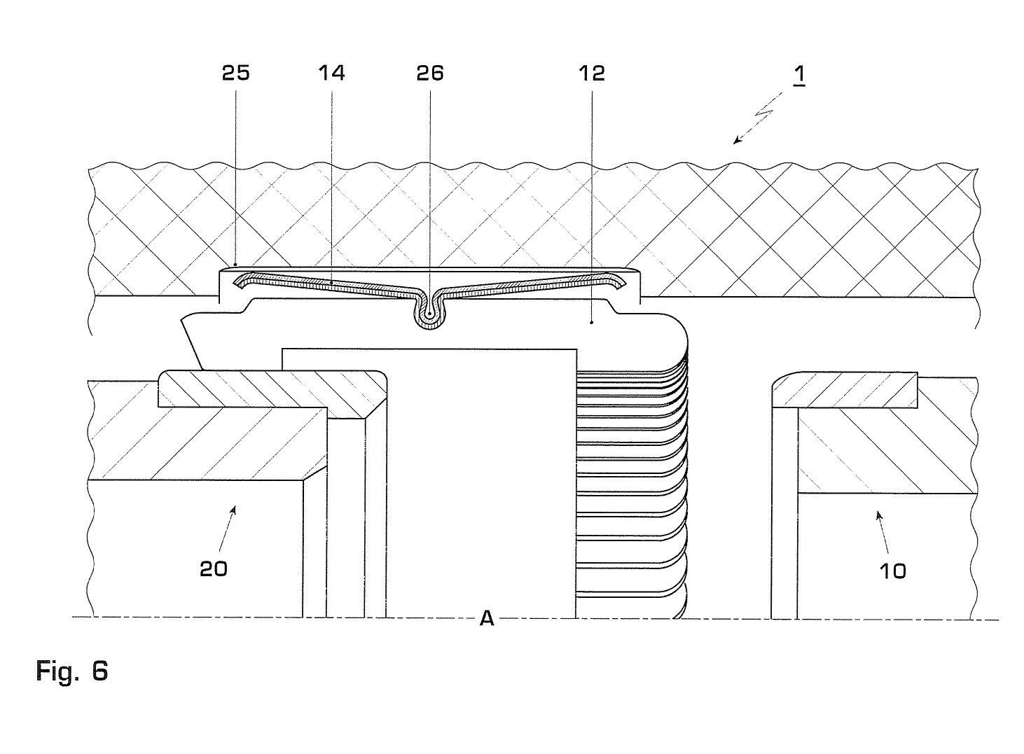

As is illustrated in FIG. 6, for a contact finger 12 which is supported by means of a bimetallic spring 14 resting on it at both ends, the force acting at the center of the finger is calculated as follows:

$$F = 0.5 \cdot \frac{77 {EJ}_{a}}{{l}^{3}} \cdot s$$

Taking account of the parameters assumed above, the force acting on the mating contact is therefore given by:

$$F = 0.5 \cdot \frac{77 \cdot 8 \cdot {10}^{4} N \cdot 208 {mm}^{4}}{{( 72 mm )}^{3} {mm}^{2}} \cdot 0.06 mm = 103 N .$$

The contact force F produced by the contact finger 12 and the bimetallic spring 14 is therefore increased by the bimetallic strip by more than 300% in comparison to that caused by a contact finger with a spring effect but without any additional force.

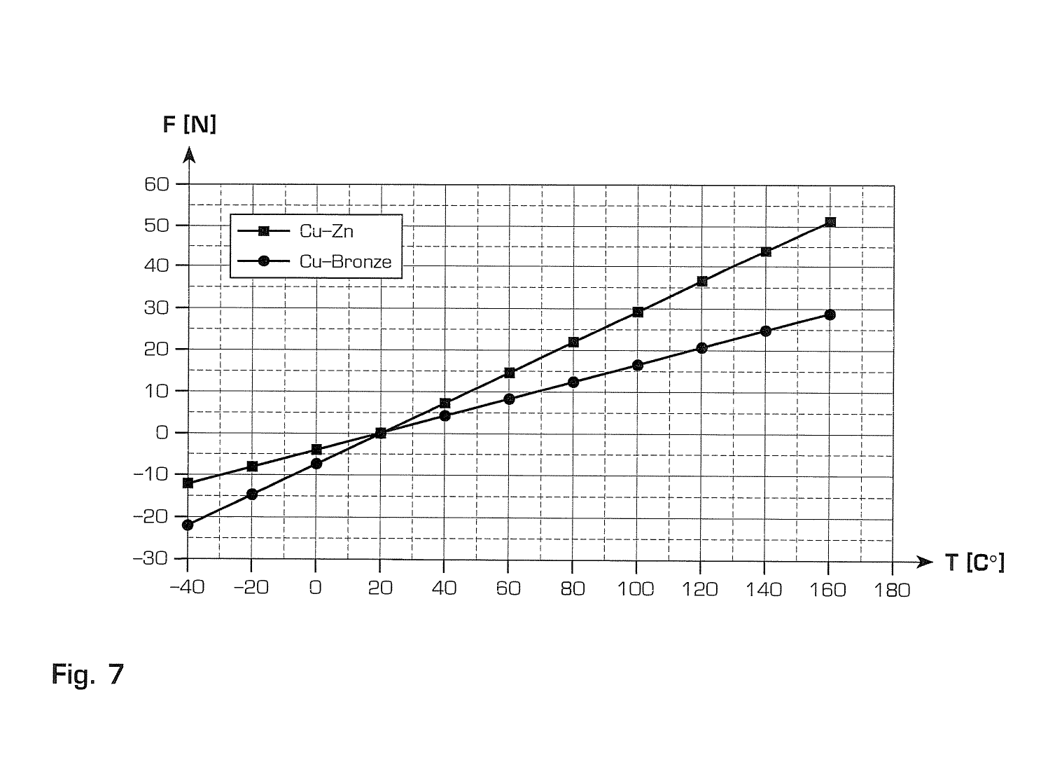

FIG. 7 shows a force/temperature diagram with the calculated force/contact temperature curves for a copper-bronze bimetallic contact finger clamped in at one end, and a copper-zinc bimetallic contact finger.

Although this is not illustrated in a further exemplary embodiment, the means for increasing the contact force, the spring element 14 and the self-sprung contact element 18 are the same means used to press the first contact unit 10 against the second contact unit 20. Both the spring element 14 and the contact element 18 in this case have a bimetallic effect. In other exemplary embodiments, the contact force is increased by producing the spring element 14 and the self-sprung contact element 18 only partially from a bimetallic strip, rather than completely, that is to say only one section of the spring element and/or of the contact element are/is composed of a bimetallic strip.

However, an increase in the contact force as the temperature rises can also be achieved by applying material with a suitable coefficient of expansion to the sprung contact element 17 and/or to the spring element 12, with a bimetallic effect being achieved in this way.

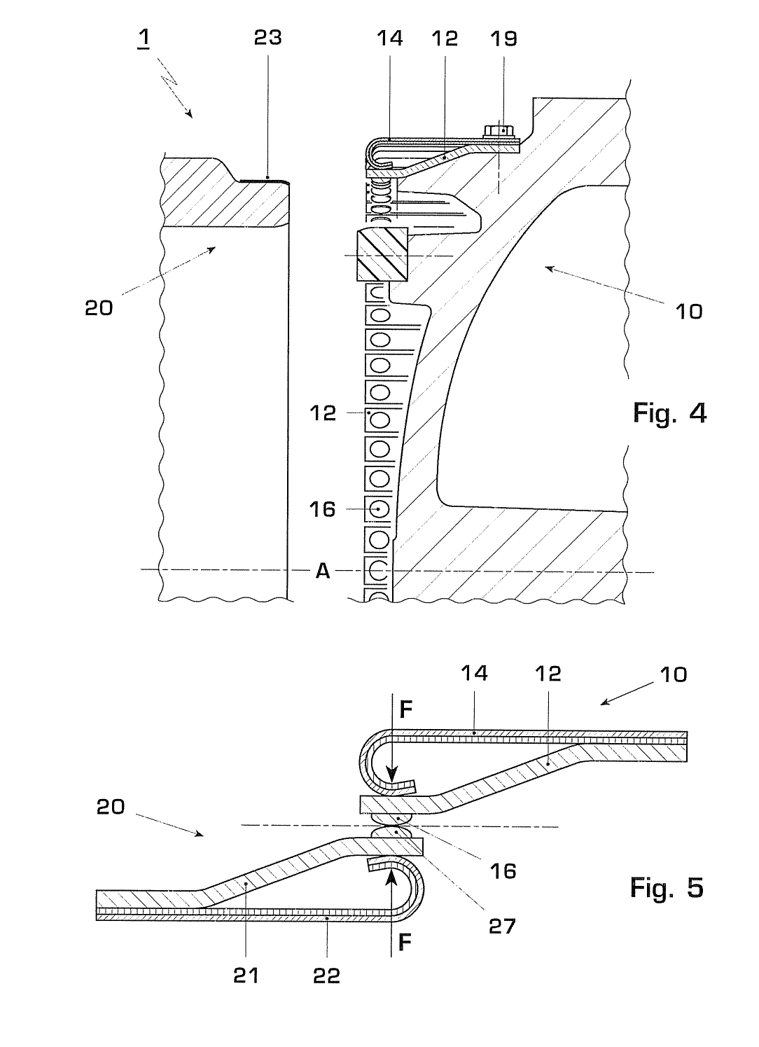

The contact system 1 according to the disclosure and illustrated in FIG. 4 for an electrical switching device is the contact system 1 for in each case one switch pole of a generator switch. The disconnector contact system 1 has a cylindrical contact unit 10 and a contact unit 20 which is in the form of a cylindrical mating contact, and these are arranged axially on the longitudinal axis A. The electrical contact for the mating contact unit 20 is produced via the contact fingers 12 of the contact unit 10, which are arranged in an annular shape on the outer surface of the contact unit 10, and are attached by screw connections 19. In order to improve the electrical conductivity, the contact surface 23 of the mating contact unit 20 is coated with silver. During operation of the generator switch, the contact system 1 is closed, and the contact fingers 12 make electrical contact with the contact unit 20, for which purpose the contact fingers 12 are pushed onto the contact surface 23 of the contact unit 20. During this process, the bimetallic springs 14 of the contact fingers 12 exert a contact force which presses the contact fingers 12 against the contact surface 23 of the mating contact unit 20. During operation of the generator switch, the contact force of the bimetallic spring 14 is increased by the contact system 1 being heated by the current flow in the contact units 10, 20, and as a result of the contact resistance between the contact units 10, 20. The increased contact force in turn leads to better electrical conductivity, that is to say to a reduction in the contact resistance between the two contact units 10, 20, and therefore to a reduction in the temperature in the contact system 1. In consequence, the contact system 1 assumes a more stable operating state, and is automatically stabilized. Furthermore, a self-healing process occurs on the contact surfaces 16, 23. This self-healing process consists in that the increase in contact resistance caused by oxidation or by aging effects is automatically reduced. The increased contact resistance on the contact surfaces 16, 23 leads to an increase in temperature in the contact units 10, 20 and therefore to increased contact force of the contact fingers 12 against the contact unit 20. The increased contact force in turn improves the electrical contact between the contact surfaces 16, 23, and therefore reduces the contact resistance. This improvement in the electrical conductivity on the contact surfaces 16, 23, which can be regarded as a self-healing effect, therefore likewise leads to more stable operating conditions for the contact system 1.

In the exemplary embodiment illustrated in FIG. 5, a finger contact 12, 21 provided with a bimetallic spring 14, 22 is used to make electrical contact both for the contact unit 10 and for the mating contact unit 20. In contrast to the exemplary embodiment illustrated in FIG. 4, both bimetallic springs 14, 22 result in an increase in the contact force, caused by the bimetallic springs, so that the spring forces of the two springs 14, 22 are added.

FIG. 6 shows the rated current contact system 1 of a generator switch with a cylindrical contact unit 10, a cylindrical mating contact unit 20 and a plurality of contact fingers 12 which are arranged in an annular shape around the contact unit 20 and are held in the circumferential recess 25 by bimetallic springs 14. Each contact finger 12 has one bimetallic spring 14. The bimetallic springs 14 are located at both ends in the recess 25 and are shaped such that a projection in the center of the springs 14 engages in a cutout 26 in the contact fingers 12. The engagement of the spring 14 and contact finger 12 in one another at a point allows the contact finger 12 to carry out a tilting movement about its attachment point. When the switch is closed, one end of the contact finger 12 in each case rests on the contact unit 10 and on the mating contact unit 20. When the contact system 1 is heated, and the bimetallic springs 14 are in consequence heated, the bimetallic effect in the springs 14 results in an increase in the contact force between the contact fingers 12 and the contact units 10, 20.

The illustrated exemplary embodiments can be varied further without departing from the scope of protection defined in the claims. For example, the contact finger 12 and the bimetallic spring 14 in FIG. 6 may also be formed integrally and they have the characteristics of a bimetallic spring. Furthermore, there is no need for the spring elements 14 or the contact finger 12, 18 to be composed of a bimetallic strip. Both the contact fingers 12, 18 and the spring elements 14 may be composed of a non-metallic substance or some other composite material which has a bimetallic effect.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

List of Reference Symbols

1 Contact system

10 Contact unit

12, 21 Contact finger, contact element

13, 22 Spring, leaf spring, spring element

14 Bimetallic spring

15 Expansion body

16, 23, 27 Contact surface

18 Bimetallic contact finger

19 Screw connection

20 Contact unit, mating contact unit

25 Recess

26 Cutout

A Axis

What is claimed is:

1. An electrical contact system for an electrical switching device having a first contact unit and a second contact unit, with a contact force acting between the first contact unit and the second contact unit when electrical contact is made, wherein means are provided to exert the contact force, wherein the first contact unit can be disconnected from the second contact unit, and wherein the means have a thermal expansion effect which results in an increase in the contact force as the temperature of the means rises.

2. The electrical contact system as claimed in claim 1, wherein the thermal expansion effect is a bimetallic effect.

3. The electrical contact system as claimed in claim 1, wherein the means which have the bimetallic effect are bimetallic strips.

4. The electrical contact system as claimed in claim 2, wherein the means for increasing the contact force have a bimetallic spring element, which has the thermal expansion effect, for pressing a first contact element of the first contact unit onto a second contact unit.

5. The electrical contact system as claimed in claim 1, wherein the means for increasing the contact force comprise a self-sprung contact element which has the thermal expansion effect, in particular a bimetallic contact element, for the contact unit.

6. The electrical contact system as claimed in claim 4, wherein the means for increasing the contact force comprises the spring element and a self-sprung contact element.

7. The electrical contact system as claimed in claim 1, wherein the means for increasing the contact force are provided on the first contact unit and on the second contact unit.

8. The electrical contact system as claimed in claim 1, wherein the means for increasing the contact force are provided on each contact element of the first contact unit and/or of the second contact unit.

9. The electrical contact system as claimed in claim 1, wherein the contact units are rated-current contact units and/or consumable contact units.

10. The electrical contact system as claimed in claim 1, wherein a bimetallic strip is fitted to a self-sprung contact element and/or to a spring element of the contact unit.

11. The electrical contact system as claimed in claim 4, wherein a self-sprung bimetallic contact element or a bimetallic spring element of the contact unit is composed entirely or partially of a bimetallic strip.

12. An electrical switching device having an electrical contact system as claimed in claim 1.

13. The electrical contact system as claimed in claim 2, wherein the means which have the bimetallic effect are bimetallic strips.

14. The electrical contact system as claimed in claim 3, wherein the means for increasing the contact force have a bimetallic spring element, which has the thermal expansion effect, for pressing a first contact element of the first contact unit onto a second contact unit.

15. The electrical contact system as claimed in claim 4, wherein the means for increasing the contact force comprise a self-sprung contact element which has the thermal expansion effect, in particular a bimetallic contact element, for the contact unit.

16. The electrical contact system as claimed in claim 5, wherein the means for increasing the contact force comprises a bimetallic spring element and the self-sprung contact element.

17. The electrical contact system as claimed in claim 6, wherein the means for increasing the contact force are provided on the first contact unit and on the second contact unit.

18. The electrical contact system as claimed in claim 7, wherein the means for increasing the contact force are provided on each contact element of the first contact unit and/or of the second contact unit.

19. The electrical contact system as claimed in claim 8, wherein the contact units are rated-current contact units and/or consumable contact units.

20. The electrical contact system as claimed in claim 9, wherein a bimetallic strip is fitted to a self-sprung contact element and/or to a spring element of the contact unit.

21. The electrical contact system as claimed in claim 6, wherein a self-sprung bimetallic contact element or a bimetallic spring element of the contact unit is composed entirely or partially of a bimetallic strip.

22. An electrical switching device configured as a circuit breaker having the electrical contact system as claimed in claim 11.
